(19) United States
(12) Patent Application Publication
(10) Pub. No.: US 2012/0099945 A1
(43) Pub. Date: Apr. 26, 2012

(54) Two-legged nail

(76) Inventor: William Stephen Lambert, Jefferson, LA (US)

(21) Appl. No.: 12/925,345

(22) Filed: Oct. 20, 2010

(51) Int. Cl. F16B 15/04

(52) U.S. Cl. 411/448

(57) ABSTRACT

The Lower Half Portion of the shaft (32) of the Common Nail is cast, stamped, sliced, sawed, laser cut, etc., centrically-lengthwise into duplicate legs (34). Their chiseled tips (38) are at a distal terminus—as depth adjusted.

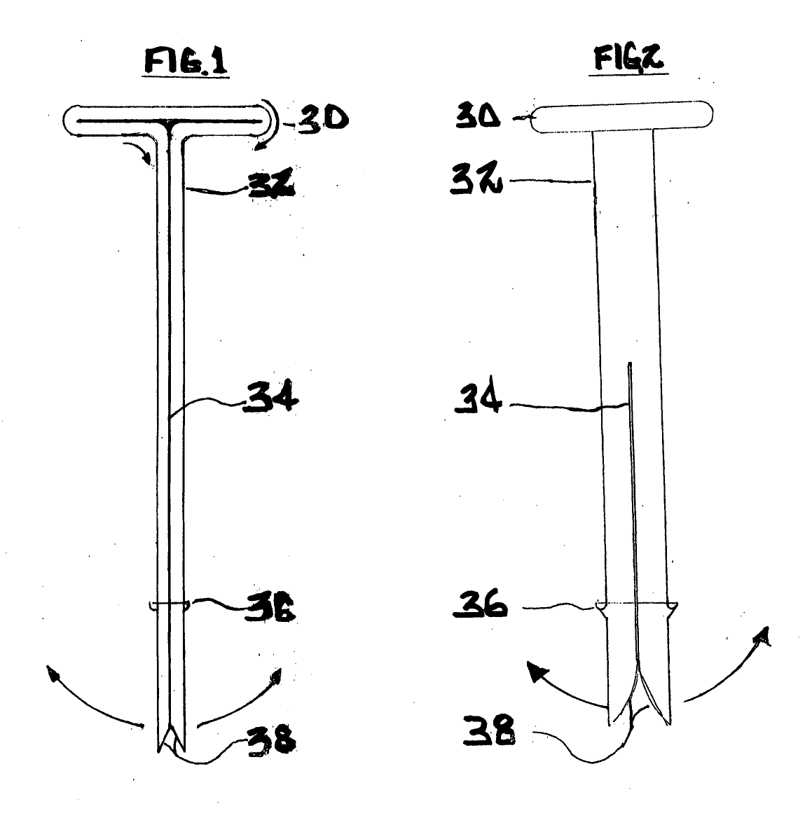

They are angularly-forced outward and away from each other to ultimately embed the legs (34) finally in-place.

An external driving force delivers the energy to embed the chisel tips (38) appropriately.

Components of instant include, sequentially, a passive driving head (30), a nail shaft (32), a pair of legs (34), and a pair of chisel tips (38).

Appendage-spreading, structural resistance to extraction is the essence of this instant.

### CROSS-REFERENCE TO RELATED APPLICATIONS

not applicable

### FEDERALLY SPONSORED RESEARCH

not applicable

### SEQUENCE LISTING OR PROGRAM

not applicable

### BACKGROUND

1. Field (small)

Applicant knows of no single-shaft, nail-like object that can passively self-anchor itself so securely as can the instant. The passive spread of the appendages incidentally self-deploy with their subsequent, irrevocable embedment into a recipient sub-stratum.

2. Prior Art

Nearly every human has driven a nail.

Currently and generally, a typical straight nail is automatically/mechanically formed from an appropriately prescribed wire stock extruded from an assembly/production line and accordingly stamped/severed therefrom with a driving head/cap pertinently complementary to an extraneous driving force (i.e., nail gun power, or a handheld hammer) along with piercing chisel tips at the distal terminus of the nail shaft.

Typically, a nail is generally and ideally utilized as a physical device to secure together layers of items of appropriately-dimensioned (and otherwise as well) recipient nail-able material, i.e., the shaft of a roofing staple, a spike into a rail/crosstie, a nail thru a two-by-four to lodge securely against and into another two-by-four, etc.

Viewed independently, the same simple, single, basic design of the common nail has had an unsolved problem since Ancient Times. That shortcoming of this indisputably wholly dependent (on an extraneous entity: i.e., the common hammer—and now the nail gun) role has persisted since Time Immemorial.

Irrespective of the method of its delivery, a single, straight-nail, omni-perpendicularly driven/installed, can be instantly extracted by effecting approximately the same, plus or minus, pressure(pounds-per-square-inch)—as so-reversed per a crow-bar or claw-hammer. Either can smoothly extract a (human or mechanical) hammer-driven nail in a second (straight-out), as compared to the time and care that same nail shaft requires to be installed—omni-perpendicularly. Instant assures resistive embedment. No other single-shafted nail is as simply resistant to extraction/removal.

Take the case of a to-be poured-in-place concrete structure: i.e., say, all of the ordinary/typical nails employed in the new carpenter's fabrication of a ready-mix/receiving/casting/form of 2×4's and plywood were erroneously driven straight on/in (versus each nail shaft driven-in at unyielding, maximally-opposing angles to the other nails. Then, the typical dynamics of the increasing downward so and sideward gross pressures of the wet, semi-fluid concrete overwhelms those insecure forms—as absent the true nail embedment(see instant) . . . As the increasingly dispersed weight/mass spreads in all directions thru out the rising lower level of the fluid concrete, the resultant unrestrained swelling ultimately pushes the insecure forms apart to spill all over. That pressure collectively caused nail pop-outs, past the point of failure, throughout the form/structure. The relative unresisting perpendicularly of the mass of all the erroneously driven, straight-on nails offered relatively minimum resistance to their retraction.

Relevantly, no other single-shaft common nail driven straight-on is as simply resistant to extraction from its typical embedment into an applicably appropriate so recipient sub strata. Another illustrative example of a failure of resistance to extraction by a (straight-in)common nail—and its relatively minimal resistance to hurricane winds. The day following a hurricane and associated tornados, the surface of the ground is littered with boards whose perpendicular nail shafts evince their relatively ineffective resistance to extraction per wind force.

Abstractly and theoretically: Trying to escape roaring flames chasing behind, an individual runs prayerfully enroute toward a boarded-up Exit door down at the end of the hall. Finally crashing into that door, which nails would one hope to find nailed thru the wooden X-Braces barricading the door? Would that individual prefer single, reversibly-extractable, directly driven, straight-on nails, or the eternally-resistant instant, Two-Legged Nails?

The instant is intended to be a one-time-use nail. Once installed, it is embedded indefinitely! The harder the extractor pull, the more resistant is the embedded Two-Legged Nail.

### SUMMARY

The lower half-portion of the shaft of the common nail is slit into duplicate appendages/legs which are forced embeddingly/outwardly apart by the resistive effect of the angularly-sharpened Chisel Tips being driven against and into a recipient substratum per the reactive energy of passively driven head of the nail.

### DRAWINGS

[Formal to Follow]

The figures in the drawing exhibit elements of the instant nail, the (passive) driving head, the shaft of the nail, the sliced appendages/legs, the appendage-spreading chisel tips (and the optional frictional retaining rings as well as any other optional, applicable abrasion/friction-increasing surface treatment—i.e., severe surface pickling, etc.).

### DRAWING REFERENCE NUMERALS

30 Driving Head
32 Nail Shaft
34 Sliced Appendage/Legs
36 Frictional-Retaining Rings
38 Chisel Tips

### DETAILED DESCRIPTION

A randomly selected First Embodiment, and likewise, a Second Embodiment are both basically similar to the venerable Common Nail. Appropriate to penetration of the various substrates to be encountered, both versions have driving heads (30) and chisel-tips (38) to facilitate easier driving, by hand/hammer, or the internal hammer in the nail-gun, and most of all, a diametrically-opposed slit (34), laser cut, stamped, or sawed down thru the lengthwise diameter/center of the nail shaft, resulting in two opposing, but identical appendages/legs (34). Optionally, a pickled effect, when extruded, is intended toward an abrasive, frictional skin surface for the length of both leg segments.

The distance between those legs is increased angularly by the outwardly dynamic effect of the skidding/“ramp-up” face of the chisel-shaped tips pushing along against say, the internal grain of the wood (say pine) substrate/recipient material. Toward timeless embedment, optional Frictional Retaining Rings (36)—protruding, effectively-gripping “lips”—annular rings—are mechanically stamped out or carved out all at once, as spaced at every five percent mark for the length of each appendage/leg (34).

In the First Embodiment, basically a common nail shaft (32) is cast, stamped, sliced, or sawed down the middle into duplicate appendages/legs (34), and at their distal terminus, its chisel tips (38) are stamped or ground down to a point as sharp as feasibly possible. These chisel-tips effect an outwardly force equally upon the legs (34), deeply embedding them completely as snuggly embraced by the in situ recipient bedding material.

This Second Embodiment, is a sequentially, pertinently stamp-formed, flattened (for added strength, optional linear corrugations/concave cross-section) wire (auto-mechanically wrought), ultimately deformed into the ultimate shape(s) of the instant as intended.

To manufacture the instant, a computer regulates and programs the automatic assembly line consisting of a 24/7 hour/day, pre-measured feed of an appropriate wire(selected per historical/applicability) for the flattening of the driving head segment and then folding it all into the final stamped-out shape of the instant nail.

In brief, and irrespective of dimension, the First Embodiment is a common nail with a partition slit about half-way up the nail shaft. On both embodiments, the two angular, chisel-sharp tips on the distal end of the nail shafts self-direct and faithfully effect, their own appropriately permanent embedment—especially into an ideally receptive medium.

Every square inch of protuberance on the skin surface of the shaft of the instant acts to help lock the instant in its final place.

Two-Legged Nail allows zero loosening movement—in any direction.

While hard metal is preferred, other materials may work . . .

### Operation.

The basic operation of the device is, by its nature, one half of a cooperative combination of two ancient, complementary contrivances. A nail is installed into or thru a receptive sub stratum per a separated, exterior driving force—i.e., as much as a pile driver, a nail gun, a sledge hammer, a tack hammer, etc.

In use, the pointed end of the appendage/leg (38) is placed on the appropriate mark and driving energy is transferred thru the driving head (30) into the nail shaft (32) and thru to completion.

### Conclusions, Ramifications, and Scope.

The importance of retention(instant) over penetration should not be understated. The relative ease of extraction of a straight-on driven nail(by hammer or nail gun) cannot compare to the extraction resistance of the instant.

One area of applicability are the industries employing low-penetration/thin-wood, i.e., kitchen cabinets, wooden shipping pallets, wooden furniture, etc.

### Ancillary Notations:

The simplicity of both these instant embodiments is best suggested by this hypothetical/actual scenario:

Touch the tip of the index finger against the tip of the thumb on one hand to form an “O” or a circle. Make a fist with the other hand, stretch out both the index finger and the adjacent middle finger. See how easily one can send these two/fingers freely in and out of the circle. Re-insert the two fingers—only this time, open the same two fingers wide and deep inside of the circle. The spread fingers won't let themselves be freed. It is the same with both of the embodiments of the Two-Legged Nail, once driven, this Nail cannot be removed. This nail is for keeps. Penetration is irrelevant to Retention. It is a case of the permanent, doubled, independent anchorage of the instant versus the standard issue common nail and its unsolved, ancient problem of the relative ease of extraction now taken for granted with that nail.

Here, a particular application prescribes design/dimensioning—per Experience . . . The primary difference between subject embodiments is the choice of delivery (method-of-manufacture with the same end-result). I.e., a common (wire) nail is ultimately fabricated into a two-legged nail and a wrought (wire) nail is ultimately fabricated into a two-legged nail.

Secure anchorage is the focus of both embodiments.

The instant is also applicable for use in the semi-automatic nail gun.

Nails (including staples) for the instant are break-away glued into loadable cartridges much as the ordinary desk paper stapler cartridges.

I claim:

1. A lower half of a shaft of a common wire nail is slit centrally lengthwise into duplicate appendages which are incidentally forced outwardly apart by so oriented angular sharpened tips upon being driven penetratingly into a recipient substratum.
